(19) United States
(12) Patent Application Publication
(10) Pub. No.: US 2023/0122800 A1
(43) Pub. Date: Apr. 20, 2023

(54) IMAGING APPARATUS AND INFORMATION PROCESSING APPARATUS

(71) Applicant: FUJIFILM Corporation, Tokyo (JP)

(72) Inventor: Hiroaki YAMAMOTO, Ashigarakami-gun (JP)

(73) Assignee: FUJIFILM Corporation, Tokyo (JP)

(21) Appl. No.: 17/954,562

(22) Filed: Sep. 28, 2022

(30) Foreign Application Priority Data
Oct. 20, 2021 (JP) 2021-171939

(51) Int. Cl. G06T 11/00

(52) U.S. Cl. CPC G06T 11/005; G06T 2210/41

(57) ABSTRACT

An imaging apparatus that generates image data including an interference fringe image by imaging an observation object existing in a culture region of a culture container, the imaging apparatus including: a plurality of light sources that irradiate the culture region with illumination light at different irradiation angles; and at least one imaging sensor that generates the image data by imaging an entirety of the culture region each time each of the plurality of light sources irradiates the culture region with the illumination light, in which the imaging apparatus is configured to be taken in and out of a culture room provided in an incubator.

### CROSS-REFERENCE TO RELATED APPLICATIONS

The present application claims priority under 35 U.S.C. § 119 to Japanese Patent Application No. 2021-171939 filed on Oct. 20, 2021. Each of the above application is hereby expressly incorporated by reference, in its entirety, into the present application.

### BACKGROUND OF THE INVENTION

### 1. Field of the Invention

The technology of the present disclosure relates to an imaging apparatus and an information processing apparatus.

### 2. Description of the Related Art

In recent years, a demand for infertility treatment has increased. An incubator for fertilized eggs is used for culturing fertilized eggs that have been subjected to in-vitro fertilization. The fertilized eggs (embryos) cultured in the incubator are transferred or frozen. The embryo refers to a fertilized egg in a dividing state.

In the related art, in order to observe fertilized eggs during culture, it has been necessary to take out a culture dish (also referred to as a tray) containing the fertilized eggs from an incubator and then observe it with a microscope. In a case where the culture dish is taken out from the incubator, a problem in that stress is applied to the fertilized eggs because of a temperature change or the like arises.

Therefore, JP2018-093795A proposes an incubator that enables observation of fertilized eggs during culture without taking out a culture dish. The incubator disclosed in JP2018-093795A includes a culture portion that holds a plurality of culture dishes in a culture environment, and an imaging unit provided corresponding to the culture dishes held in the culture portion. As disclosed in JP2018-093795A, an incubator that enables observation of the fertilized eggs without removing the culture dish from the culture portion while culturing the fertilized eggs in the culture dish is called a time-lapse incubator.

since the imaging unit disclosed in JP2018-093795A is an optical camera having a lens, a focus is adjusted by moving the lens along an optical axis. Human eggs are substantially spherical and have a diameter of about 100 to 150 μm. It is unknown at which position of the eggs the presence of the pronucleus or the like, which is a clue for determining fertilization of the eggs, exists. Therefore, the imaging unit disclosed in JP2018-093795A captures a plurality of images having different focal positions.

Although, in the related art, a microscope such as a phase contrast microscope has been used for observing cells or the like as in the apparatus disclosed in JP2018-093795A, it is necessary to perform focusing in imaging an observation object. Therefore, in recent years, lens-free digital holography, which does not require focusing in imaging an observation object, has been used (see, for example, JP2012-531584A).

In digital holography, an interference fringe image generated by irradiating an observation object with coherent light such as a laser beam is captured, and the interference fringe image obtained by the imaging is reconstructed, whereby a reconstructed image (so-called tomographic image) at an optional focal position can be generated.

### SUMMARY OF THE INVENTION

In culturing fertilized eggs, a plurality of fertilized eggs may be cultured per one culture dish. For example, JP2018-093795A discloses that four fertilized eggs are simultaneously imaged. However, since the imaging unit disclosed in JP2018-093795A is an optical camera having a lens for performing magnified imaging, there is a problem that a size of the apparatus becomes large in a case where the imaging unit is mounted in the incubator. The apparatus disclosed in JP2018-093795A is not suitable for a small incubator for fertilized eggs because the size of the apparatus becomes larger as the number of optical cameras is increased in order to image more fertilized eggs.

Meanwhile, JP2012-531584A discloses that fertilized eggs in an incubator are imaged by the lens-free digital holography, but does not disclose that a plurality of fertilized eggs are simultaneously imaged.

In a case where a plurality of fertilized eggs cultured in a culture dish are simultaneously imaged, there is a problem in that it is difficult to accurately image all fertilized eggs in a culture region.

As described above, in a case where cells such as fertilized eggs are cultured, an imaging apparatus having a small apparatus size and capable of accurately imaging the entirety of a culture region is desired.

An object of the technology of the present disclosure is to provide an imaging apparatus and an information processing apparatus, which have a small apparatus size and can accurately image the entirety of a culture region.

In order to achieve the above-described object, provided is an imaging apparatus that generates image data including an interference fringe image by imaging an observation object existing in a culture region of a culture container, the imaging apparatus comprising: a plurality of light sources that irradiate the culture region with illumination light at different irradiation angles; and at least one imaging sensor that generates the image data by imaging an entirety of the culture region each time each of the plurality of light sources irradiates the culture region with the illumination light, in which the imaging apparatus is configured to be taken in and out of a culture room provided in an incubator.

It is preferable that the observation object is a fertilized egg or a floating cell.

It is preferable that a plurality of the observation objects exist in the culture region, and that the imaging sensor simultaneously images the plurality of observation objects.

It is preferable that the light source has a plurality of light emitting points, and that the imaging sensor generates a plurality of pieces of the image data by performing an imaging operation each time each of the light emitting points emits light.

It is preferable that a plurality of the imaging sensors are provided, and that one imaging sensor is provided for each observation object existing in the culture region.

It is preferable that the imaging apparatus further comprises a communication unit that wirelessly transmits the image data.

An information processing apparatus of the present disclosure comprises: a processor that generates a reconstructed image by receiving the image data transmitted from the imaging apparatus described above and performing a reconstruction process based on the received image data.

It is preferable that the processor specifies an observation object region in which the observation object exists based on pre-imaging data outputted from the imaging apparatus obtained by imaging the entirety of the culture region with one of the plurality of light sources before executing the imaging operation for generating the image data, and generates the reconstructed image by extracting an image corresponding to the observation object region from the image data and performing the reconstruction process on the extracted image.

It is preferable that the processor specifies an observation object region in which the observation object exists based on information of the culture container, and generates the reconstructed image by extracting an image corresponding to the observation object region from the image data and performing the reconstruction process on the extracted image.

It is preferable that the processor generates a synthetic image by performing a synthetic aperture process on a plurality of the reconstructed images corresponding to the plurality of light sources.

According to the technology of the present disclosure, it is possible to provide an imaging apparatus and an information processing apparatus, which have a small apparatus size and can accurately image the entirety of a culture region.

### BRIEF DESCRIPTION OF THE DRAWINGS

FIG. 1 is a perspective view showing an example of an imaging apparatus.

FIG. 2 is a side view of an imaging apparatus on which a culture container is placed.

FIG. 3 is a diagram showing an example of a relationship between a culture region and an imaging surface.

FIG. 4 is a diagram showing an example of a configuration of an imaging sensor.

FIG. 5 is a diagram showing a state in which an interference fringe image is generated by irradiating a fertilized egg with illumination light.

FIG. 6 is a diagram showing an example of image data generated by the imaging sensor.

FIG. 7 is a schematic view showing an example of a configuration of a time-lapse imaging system.

FIG. 8 is a block diagram showing an example of an internal configuration of an imaging apparatus and an information processing apparatus.

FIG. 9 is a block diagram showing an example of a functional configuration of the information processing apparatus.

FIG. 10 is a diagram showing an example of a reconstruction position.

FIG. 11 is a flowchart showing an example of the overall operation of the time-lapse imaging system.

FIG. 12 is a schematic view showing a configuration of a light emitting surface of a light source according to a modification example.

FIG. 13 is a side view of an imaging apparatus according to the modification example.

FIG. 14 is a block diagram showing a functional configuration of an information processing apparatus according to a second embodiment.

FIG. 15 is a diagram showing an example of an observation object region.

FIG. 16 is a diagram showing an example of an image extraction process.

FIG. 17 is a flowchart showing an example of the overall operation of a time-lapse imaging system according to the second embodiment.

FIG. 18 is a diagram showing a culture container according to the modification example.

FIG. 19 is a block diagram showing a functional configuration of an information processing apparatus according to the modification example.

### DESCRIPTION OF THE PREFERRED EMBODIMENTS

An example of an embodiment relating to the technology of the present disclosure will be described with reference to the accompanying drawings.

### First Embodiment

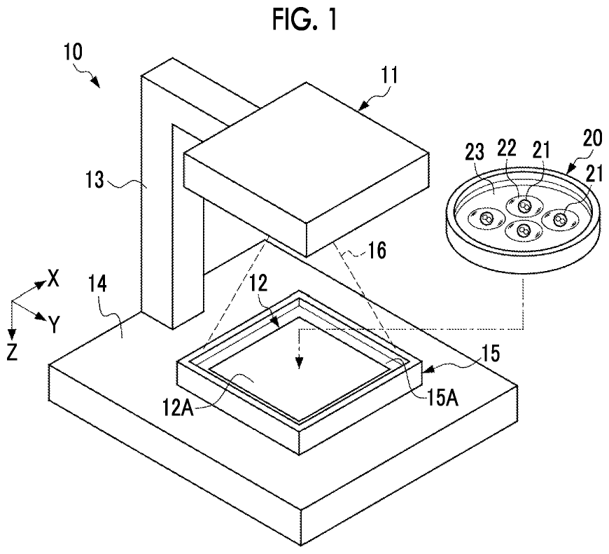

FIG. 1 shows an imaging apparatus 10 according to a first embodiment. The imaging apparatus 10 includes an illumination device 11, an imaging sensor 12, a support column 13, a base 14, and a stage 15. The imaging apparatus 10 performs so-called lens-free imaging in which an observation object is imaged without using an optical lens.

The illumination device 11 is connected to one end of a substantially L-shaped support column 13. The other end of the support column 13 is connected to the base 14. The base 14 has a flat plate shape, and the stage 15 is provided substantially in the center. The stage 15 is provided with a recessed placing part 15A on which a culture container 20 for culturing fertilized eggs is placed. The support column 13 supports the illumination device 11 such that the illumination device 11 faces an imaging surface 12A of the imaging sensor 12. The fertilized egg is an example of an “observation object” according to the technology of the present disclosure.

Hereinafter, a direction in which the illumination device 11 and the imaging surface 12A face each other is referred to as a Z direction. One direction orthogonal to the Z direction is referred to as an X direction. A direction orthogonal to the Z direction and the X direction is called a Y direction. The imaging surface 12A is orthogonal to the Z direction and is parallel to the X direction and the Y direction.

The imaging sensor 12 is composed of, for example, a monochrome complementary metal oxide semiconductor (CMOS) imaging sensor. The culture container 20 is placed on the imaging surface 12A of the imaging sensor 12. The culture container 20 is a shallow cylindrical container, and is also called a culture dish. The culture container 20 is transparent and transmits illumination light 16 emitted from the illumination device 11. A diameter of the culture container 20 is about 30 to 60 mm. A thickness of the culture container 20 is about 10 to 20 mm. The size and/or the shape of the culture container are/is not limited thereto and can be appropriately changed according to the required performance for capable of accurately imaging the observation object existing in a culture region of a culture container.

A plurality of fertilized eggs 21 that have been subjected to in-vitro fertilization are sown in the culture container 20. Examples of the in-vitro fertilization include microinsemination performed under a microscope and normal in-vitro fertilization in which an egg and a sperm are treated together in a predetermined container. A method of fertilizing the fertilized eggs 21 to be cultured does not matter. The fertilized egg 21 is, for example, a human fertilized egg. The fertilized egg 21 is substantially spherical and has a diameter of about 100 to 200 μm.

Each of the fertilized eggs 21 floats in a culture solution 22 added dropwise into the culture container 20. The culture solution 22 is covered with oil 23 filling the culture container 20. The oil 23 suppresses evaporation of the culture solution 22 and a change in pH. The fertilized egg 21 in a dividing state is also called an embryo. The fertilized egg 21 in the present disclosure includes an embryo.

In the culture container 20, a plurality of fertilized eggs 21 are imaged by the imaging apparatus 10 in a state where the culture container 20 is covered with a translucent lid (not shown).

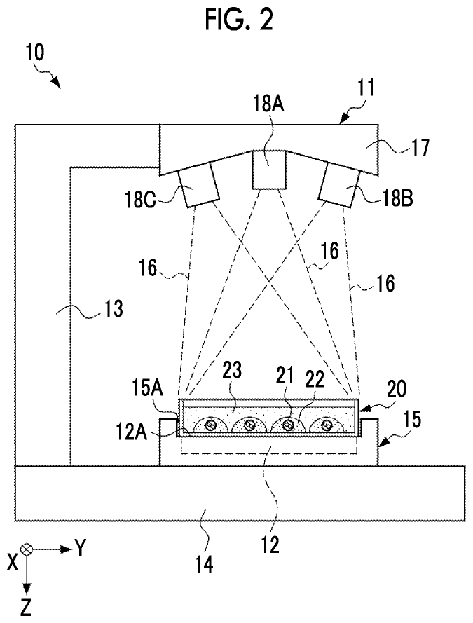

FIG. 2 is a side view of the imaging apparatus 10 on which the culture container 20 is placed. As shown in FIG. 2, the illumination device 11 includes a base 17 and three light sources 18A, 18B, and 18C. The base 17 is connected to the support column 13. The light sources 18A, 18B, and 18C are provided on a surface of the base 17 facing the stage 15.

The light sources 18A, 18B, and 18C are each composed of, for example, a laser diode, and emit the illumination light 16 toward the stage 15. The light sources 18A, 18B, and 18C may be configured by combining a light emitting diode and a pinhole, respectively. The illumination light 16 is coherent light. A wavelength of the illumination light 16 is 640 nm, 780 nm, or the like. The illumination light 16 is radiation light.

The light sources 18A, 18B, and 18C have different irradiation angles of the illumination light 16 with respect to the imaging surface 12A of the imaging sensor 12. The light source 18A is mounted at a position facing the center of the imaging surface 12A of the base 17, and emits the illumination light 16 from a direction substantially orthogonal to the imaging surface 12A.

The light source 18B is mounted at a position deviated from the mounting position of the light source 18A of the base 17 in the +Y direction, and emits the illumination light 16 from an oblique direction with respect to the imaging surface 12A. The light source 18C is mounted at a position deviated from the mounting position of the light source 18A of the base 17 in the −Y direction, and emits the illumination light 16 from an oblique direction with respect to the imaging surface 12A. The light source 18B and the light source 18C are disposed at positions symmetrical with respect to the light source 18A in the Y direction. In addition, the light source 18B and the light source 18C are disposed on an inclined surface formed on the base 17.

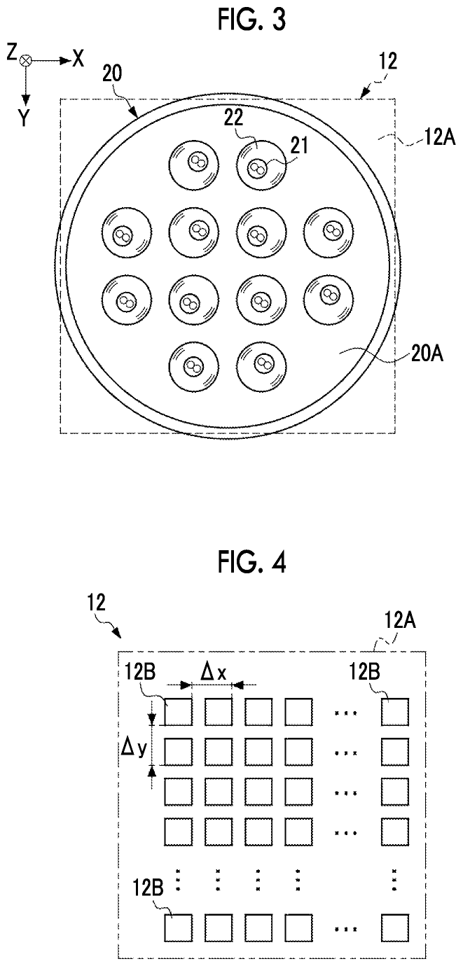

The light sources 18A, 18B, and 18C each irradiate the entirety of a culture region with the illumination light 16. Here, the culture region is a region in which a plurality of fertilized eggs 21 are cultured in the culture container 20. For example, the culture region refers to the entirety of an inner bottom surface 20A (see FIG. 3) of the culture container 20.

The imaging sensor 12 detects the illumination light 16 emitted from each of the light sources 18A, 18B, and 18C and transmitted through the culture container 20. Specifically, the illumination light 16 is incident into the culture container 20, and the illumination light 16 is diffracted by the fertilized egg 21, so that an interference fringe image reflecting a shape and an internal structure of the fertilized egg 21 is generated. The interference fringe image is also called a hologram image. The imaging sensor 12 simultaneously captures a plurality of interference fringe images generated by the plurality of fertilized eggs 21.

As shown in FIG. 3, the imaging sensor 12 has an imaging surface 12A having a larger area than the culture region in order to image the culture region (that is, the entirety of the inner bottom surface 20A of the culture container 20). For example, 12 fertilized eggs are cultured in the culture region of the culture container 20, and the imaging sensor 12 simultaneously captures 12 interference fringe images generated by the illumination light 16 incident into the 12 fertilized eggs.

FIG. 4 shows an example of a configuration of the imaging sensor 12. The imaging sensor 12 has a plurality of pixels 12B disposed on the imaging surface 12A. The pixel 12B is a photoelectric conversion element that outputs a pixel signal according to the amount of incidence light by photoelectrically converting the incidence light.

The pixels 12B are arranged at equal pitches along the X direction and the Y direction. The array of the pixels 12B is a so-called square array. The X direction is a direction orthogonal to the Z direction. The Y direction is a direction orthogonal to the X direction and the Z direction. The pixels 12B are arranged at a first arrangement pitch Δx in the X direction and are arranged at a second arrangement pitch Δy in the Y direction.

The imaging sensor 12 images the light incident on the imaging surface 12A, and outputs image data DT composed of the pixel signal output from each of the pixels 12B.

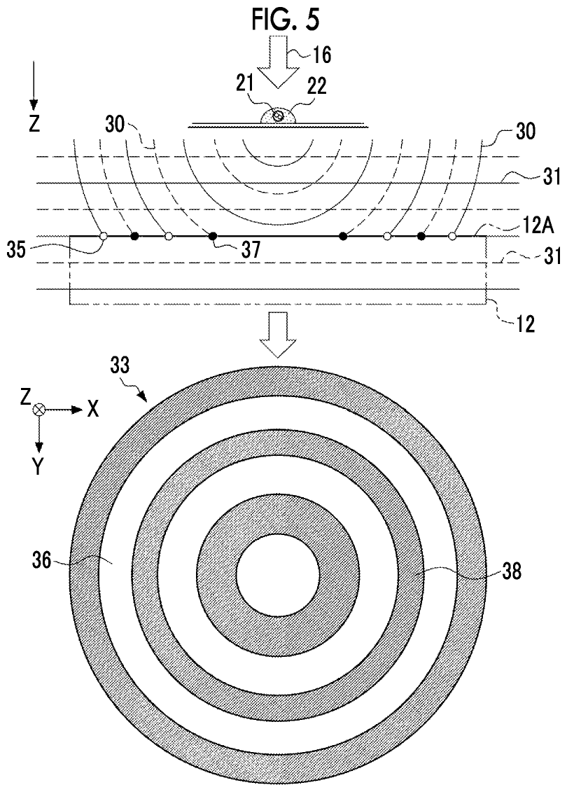

FIG. 5 shows a state in which an interference fringe image is generated by irradiating one fertilized egg 21 with the illumination light 16. A part of the illumination light 16 incident into the culture container 20 is diffracted by the fertilized egg 21. That is, the illumination light 16 is divided into diffracted light 30 diffracted by the fertilized egg 21 and transmitted light 31 that is not diffracted by the fertilized egg 21 and is transmitted through the culture container 20. The transmitted light 31 is a spherical wave or a plane wave. The diffracted light 30 and the transmitted light 31 are transmitted through the bottom surface of the culture container 20 and are incident on the imaging surface 12A of the imaging sensor 12.

The diffracted light 30 and the transmitted light 31 interfere with each other to generate an interference fringe image 33. The interference fringe image 33 is composed of a bright portion 36 and a dark portion 38. In FIG. 5, although the interference fringe image 33 shows the bright portion 36 and the dark portion 38 as circles, a shape of the interference fringe image 33 changes according to the shape and the internal structure of the fertilized egg 21. The imaging sensor 12 simultaneously captures optical images including a plurality of interference fringe images 33 formed on the imaging surface 12A, and outputs image data DT including the plurality of interference fringe images 33.

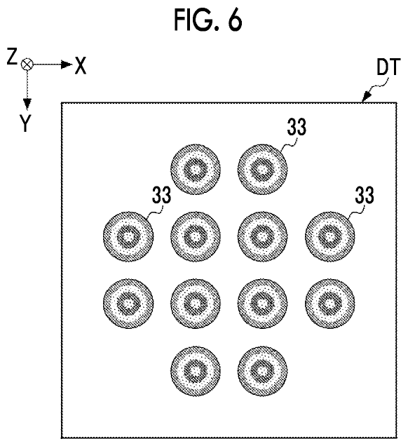

FIG. 6 shows an example of the image data DT generated by the imaging sensor 12. The image data DT includes the interference fringe images 33 whose number corresponds to the number of the fertilized eggs 21 cultured in the culture region of the culture container 20. The imaging sensor 12 outputs the image data DT by imaging the culture region each time the illumination light 16 is applied to the culture region from each of the light sources 18A, 18B, and 18C.

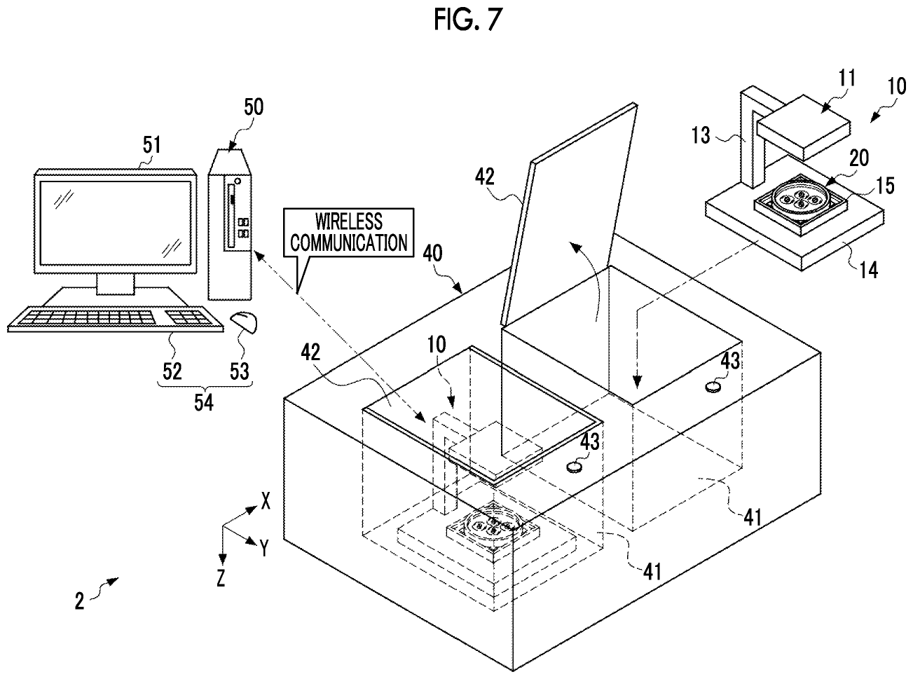

FIG. 7 shows an example of the configuration of a time-lapse imaging system. As shown in FIG. 7, a time-lapse imaging system 2 includes an imaging apparatus 10, an incubator 40, and an information processing apparatus 50. The incubator 40 is a multi-room incubator for fertilized eggs and is also called an embryo culture device. The fertilized eggs 21 are cultured in the incubator 40 for a predetermined period (for example, 7 days).

The incubator 40 has a plurality of culture rooms 41 rather than one culture room like a general incubator for culturing cells other than fertilized eggs. This is because the imaging apparatus 10 is accommodated in each of the culture rooms 41, so that the fertilized eggs 21 are individually managed so as not to be confused with the fertilized eggs 21 of another person. The culture room 41 is also called a culture chamber. Although the incubator 40 shown in FIG. 7 is provided with two culture rooms 41, the number of the culture rooms 41 is not limited thereto and can be changed as appropriate.

Each of the culture rooms 41 is provided with an openable and closable lid 42. The incubator 40 is provided with a switch 43 for opening and closing the lid 42 for each culture room 41. In a case where a user operates the switch 43, the lid 42 is opened and closed by a drive mechanism (not shown). The lid 42 may be manually opened and closed. The culture room 41 is kept airtight in a case where the lid 42 is closed.

A mixed gas obtained by mixing carbon dioxide (CO₂) gas and nitrogen (N₂) gas with outside air is supplied to the culture room 41 from an external gas cylinder (not shown) via a high efficiency particulate air (HEPA) filter. A heater (not shown) is provided on side surfaces and a bottom surface of the culture room 41. A culture environment of the culture room 41 is kept constant by controlling the concentration, temperature, and humidity of the mixed gas to be constant.

The imaging apparatus 10 has a size enough to be taken in and out of the culture room 41. As shown in FIG. 7, one imaging apparatus 10 is inserted into one culture room 41. That is, the lid 42 can be closed in a state where the imaging apparatus 10 on which the culture container 20 is placed is inserted into the culture room 41. Thus, while the plurality of fertilized eggs 21 are cultured in the culture room 41, the plurality of fertilized eggs 21 can be imaged by the imaging apparatus 10 without taking out the culture container 20 from the culture room 41.

The information processing apparatus 50 is, for example, a desktop personal computer. A display 51, a keyboard 52, and a mouse 53 are connected to the information processing apparatus 50. The keyboard 52 and the mouse 53 constitute an input device 54 for the user to input information. The input device 54 also includes a touch panel and the like.

The information processing apparatus 50 exchanges data with the imaging apparatus 10 accommodated in each of the culture rooms 41 by wireless communication. The imaging apparatus 10 performs imaging periodically (for example, every 5 to 15 minutes). The information processing apparatus 50 periodically receives image data including the interference fringe image 33 (see FIG. 5) from the imaging apparatus 10, performs a reconstruction process based on the received image data, and displays a reconstructed image generated by the reconstruction process. The reconstructed image is also called a tomographic image.

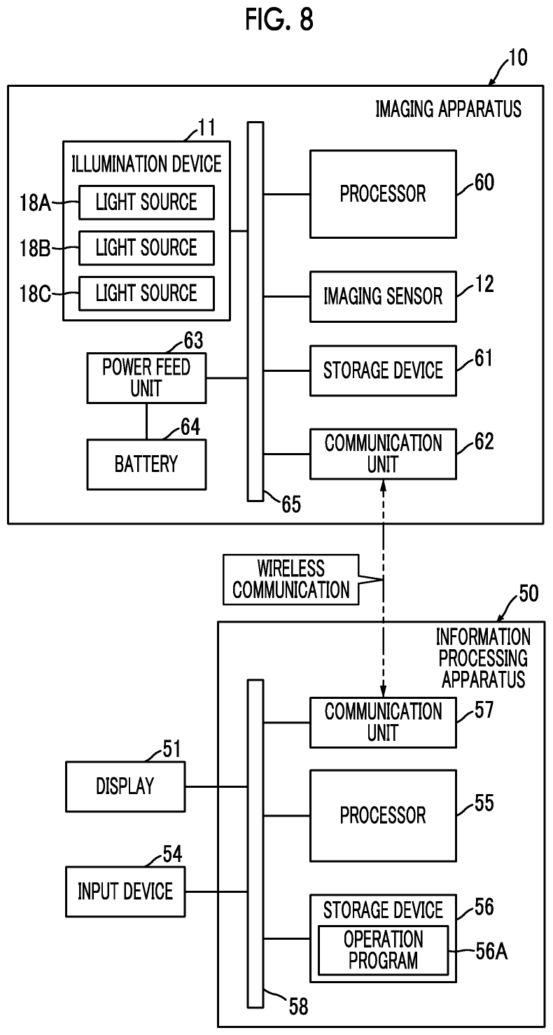

FIG. 8 shows an example of an internal configuration of the imaging apparatus 10 and the information processing apparatus 50. As shown in FIG. 8, in addition to the illumination device 11 and the imaging sensor 12, the imaging apparatus 10 comprises a processor 60, a storage device 61, a communication unit (also referring to communication portion) 62, a power feed unit 63, and a battery 64, which are interconnected via a busline 65.

The processor 60 is, for example, a field programmable gate array (FPGA) and controls an operation of each part in the imaging apparatus 10. The storage device 61 is a random access memory (RAM), a flash memory, or the like. The storage device 61 stores the image data generated by the imaging apparatus 10 and various kinds of data.

The communication unit 62 performs wireless communication with the information processing apparatus 50. The processor 60 transmits the image data to the information processing apparatus 50 via the communication unit 62.

The battery 64 is a secondary battery such as a lithium polymer battery. The power feed unit 63 includes a power supply circuit and a charge control circuit. The power feed unit 63 supplies power supplied from the battery 64 to the processor 60. In addition, the power feed unit 63 controls charging of the battery 64 by power supplied from the outside. The power feed unit 63 may be configured to charge the battery 64 wirelessly.

The information processing apparatus 50 comprises a processor 55, a storage device 56, and a communication unit 57, which are interconnected via a busline 58. The display 51 and the input device 54 described above are connected to the busline 58.

The processor 55 is composed of, for example, a central processing unit (CPU), and realizes various functions by reading out an operation program 56A and various kinds of data stored in the storage device 56 and executing processing.

The storage device 56 includes, for example, a RAM, a read only memory (ROM), and a storage. The RAM is, for example, a volatile memory used as a work area or the like. The ROM is, for example, a non-volatile memory such as a flash memory that holds the operation program 56A and various kinds of data. The storage is, for example, a hard disk drive (HDD) or a solid state drive (SSD). The storage stores an operating system (OS), an application program, image data, various kinds of data, and the like.

The communication unit 57 performs wireless communication with the communication unit 62 of the imaging apparatus 10. The processor 55 receives the image data transmitted from the imaging apparatus 10 via the communication unit 57. In addition, the processor 55 transmits, to the imaging apparatus 10, a control signal for controlling imaging via the communication unit 57.

The display 51 displays various screens. The information processing apparatus 50 receives input of an operation instruction from the input device 54 through various screens.

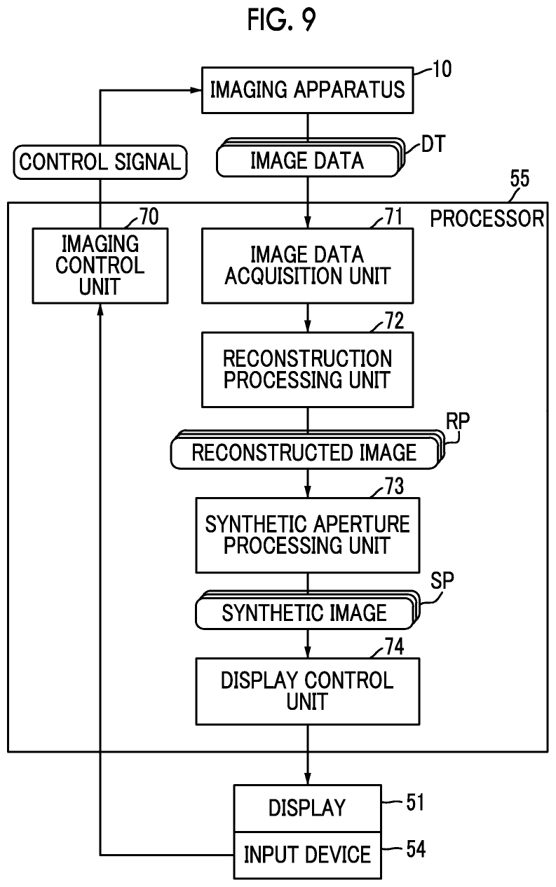

FIG. 9 shows an example of a functional configuration of the information processing apparatus 50. The function of the information processing apparatus 50 is realized by the processor 55 executing processing based on the operation program 56A. As shown in FIG. 9, the processor 55 includes an imaging control unit 70, an image data acquisition unit 71, a reconstruction processing unit 72, a synthetic aperture processing unit 73, and a display control unit 74.

The imaging control unit 70 controls an operation of the imaging apparatus 10. Specifically, the imaging control unit 70 controls an operation of generating the illumination light 16 by the illumination device 11 and an imaging operation of the imaging sensor 12 by transmitting a control signal to the imaging apparatus 10. More specifically, the imaging control unit 70 sequentially emits the illumination light 16 from the light sources 18A, 18B, and 18C included in the illumination device 11, and causes the imaging sensor 12 to perform the imaging operation each time the illumination light 16 is emitted.

Hereinafter, the operation of generating the illumination light 16 by the illumination device 11 and the imaging operation of the imaging sensor 12 are collectively referred to as an imaging operation of the imaging apparatus 10. The imaging control unit 70 causes the imaging apparatus 10 to start the imaging operation based on an operation signal input from the input device 54.

The image data acquisition unit 71 acquires three pieces of generated image data DT transmitted from the imaging apparatus 10 after the imaging apparatus 10 images the plurality of fertilized eggs 21 in the culture container 20. The three pieces of image data DT correspond to the light sources 18A, 18B, and 18C, and have different irradiation angles of the illumination light 16 with respect to the imaging surface 12A of the imaging sensor 12. The image data acquisition unit 71 supplies the three pieces of image data DT acquired from the imaging apparatus 10 to the reconstruction processing unit 72.

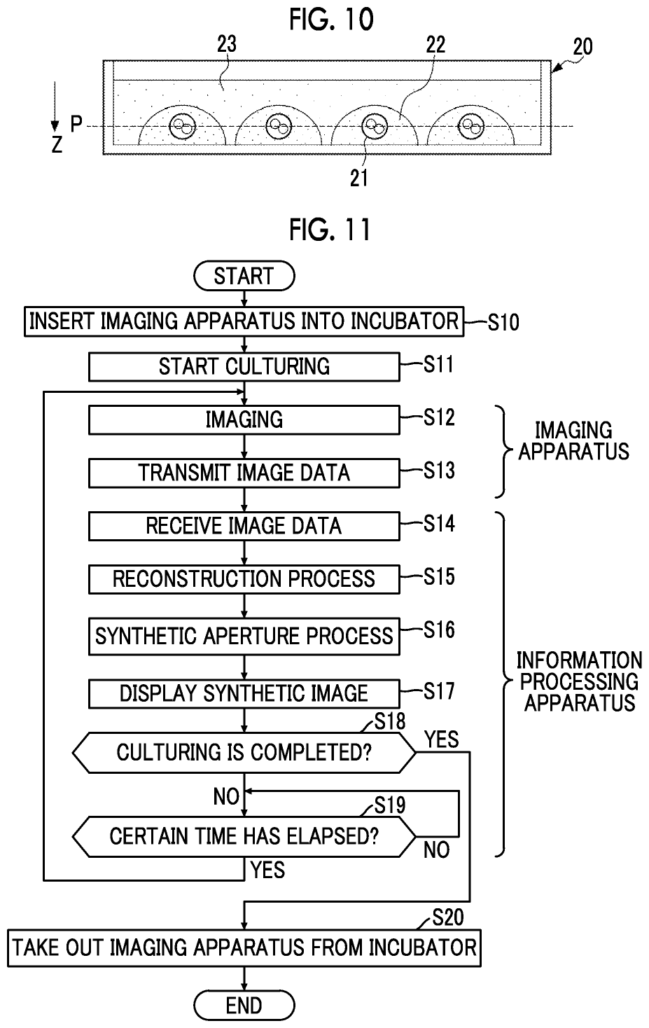

The reconstruction processing unit 72 generates three reconstructed images RP by performing an operation based on each of the three pieces of image data DT supplied from the image data acquisition unit 71. For example, as shown in FIG. 10, the reconstruction processing unit 72 generates the reconstructed image RP for a predetermined reconstruction position P which is a height at which the fertilized egg 21 is present. The reconstruction position P is a position (so-called depth position) represented by a distance d from the imaging surface 12A of the imaging sensor 12 in the direction of the illumination device 11. The reconstruction position P may be set or changed by the user operating the input device 54.

The reconstruction processing unit 72 performs a reconstruction process based on, for example, Fresnel transform equations represented by Equations (1) to (3).

$$Γ ( m , n ) = \frac{i}{λ d} exp ( - i \frac{2 π}{λ} d ) exp [ - i π λ d ( \frac{{m}^{2}}{{N}_{x}^{2} Δ {x}^{2}} + \frac{{n}^{2}}{{N}_{y}^{2} Δ {y}^{2}} ) ] \times {{\sum }_{x = 0}}^{{N}_{x} - 1} {{\sum }_{y = 0}}^{{N}_{y} - 1} I ( x , y ) exp [ - i \frac{π}{λ d} ( {x}^{2} Δ {x}^{2} + {y}^{2} Δ {y}^{2} ) ] exp [ i 2 π ( \frac{xm}{{N}_{x}^{2}} + \frac{yn}{{N}_{y}^{2}} ) ] \qquad ( 1 )$$

$${A}_{0} ( m , n ) = {\vert Γ ( m , n ) \vert}^{2} \qquad ( 2 )$$

$${φ}_{0} ( m , n ) = arc tan \frac{Im [ Γ ( m , n ) ]}{Re [ Γ ( m , n ) ]} \qquad ( 3 )$$

Here, I(x,y) represents image data. x represents coordinates of the pixel 12B (see FIG. 4) of the imaging sensor 12 in the X direction. y represents coordinates of the pixel 12B in the Y direction. Δx is the above-described first arrangement pitch, and Δy is the above-described second arrangement pitch (see FIG. 4). λ is a wavelength of the illumination light 16.

As shown in Equation (1), Γ(m,n) represents a complex amplitude image in which an interference fringe image included in the image data is Fresnel-transformed. Here, m=1, 2, 3, . . . Nx−1 and n=1, 2, 3, . . . Ny−1. Nx represents the number of pixels in the X direction of the image data. Ny represents the number of pixels in the Y direction of the image data.

As shown in Equation (2), Δ₀(m, n) represents an intensity distribution image representing an intensity component of the complex amplitude image Γ(m,n). As shown in Equation (3), φ₀(m,n) represents a phase distribution image representing a phase component of the complex amplitude image Γ(m,n).

The reconstruction processing unit 72 obtains the complex amplitude image Γ(m,n) based on Equation (1), and applies the obtained complex amplitude image Γ(m,n) to Equation (2) or Equation (3), whereby the intensity distribution image A₀(m,n) or the phase distribution image φ₀(m,n) is obtained. The reconstruction processing unit 72 obtains any one of the intensity distribution image A₀(m,n) or the phase distribution image φ₀(m,n) and outputs the obtained image as the reconstructed image RP.

In the present embodiment, the reconstruction processing unit 72 outputs the phase distribution image φ₀(m,n) as the reconstructed image RP. The phase distribution image φ₀(m,n) is an image showing a refractive index distribution of the observation object. Since the fertilized egg 21, which is the observation object in the present embodiment, is translucent, a major part of the illumination light 16 is transmitted or diffracted without being absorbed by the fertilized egg 21, so that almost no image appears in the intensity distribution. Therefore, in the present embodiment, it is preferable to use the phase distribution image φ₀(m,n) as the reconstructed image RP.

The reconstruction processing unit 72 is not limited to the method using the Fresnel transform equation, and may perform the reconstruction process by a Fourier iterative phase retrieval method or the like.

The reconstruction processing unit 72 generates three reconstructed images RP by performing the reconstruction process on each of the three pieces of image data DT supplied from the image data acquisition unit 71. The reconstruction processing unit 72 supplies the generated three reconstructed images RP to the synthetic aperture processing unit 73. The three reconstructed images RP correspond to the light sources 18A, 18B, and 18C, and have different irradiation angles of the illumination light 16 with respect to the imaging surface 12A of the imaging sensor 12.

The synthetic aperture processing unit 73 generates a synthetic image SP by performing a synthetic aperture process on the three reconstructed images RP supplied from the reconstruction processing unit 72. Specifically, the synthetic aperture processing unit 73 performs a Fourier transform on each of the three reconstructed images RP to synthesize them in a frequency space, and performs an inverse Fourier transform on the synthesized frequency data to generate a synthetic image SP. The three reconstructed images RP are images in which the irradiation angles of the illumination light 16 with respect to the observation object are different. Therefore, by synthesizing the three reconstructed images in a frequency space, high-frequency components of the observation object are taken in, and a high-resolution synthetic image SP with high spatial resolution is obtained.

The display control unit 74 causes the display 51 to display the synthetic image SP generated by the synthetic aperture processing unit 73. In the present embodiment, the display control unit 74 causes the display 51 to display the synthetic image SP corresponding to one reconstruction position P, and may cause the display 51 to display a plurality of synthetic images SPs corresponding to a plurality of reconstruction positions P.

Next, an example of the overall operation of the time-lapse imaging system 2 will be described with reference to a flowchart shown in FIG. 11. First, the user places the culture container 20 on the stage 15 of the imaging apparatus 10, and then inserts the imaging apparatus 10 into the culture room 41 of the incubator 40 (Step S10). The imaging apparatus 10 need only be inserted into at least one of the plurality of culture rooms 41.

Next, the user closes the lid 42 of the culture room 41 and causes the incubator 40 to start culturing (Step S11). In a case where the incubator 40 starts culturing, the imaging apparatus 10 images the plurality of fertilized eggs 21 to be cultured in the culture region in the culture container 20 under the control of the information processing apparatus 50 (Step S12). The imaging apparatus 10 wirelessly transmits the three pieces of image data DT generated by performing the imaging operation to the information processing apparatus 50 (Step S13).

The information processing apparatus 50 receives the three pieces of image data DT transmitted from the imaging apparatus 10 (Step S14). The reconstruction processing unit 72 of the information processing apparatus 50 generates three reconstructed images RP corresponding to at least one reconstruction position P by performing the reconstruction process on each of the three pieces of image data DT (Step S15). The synthetic aperture processing unit 73 generates the synthetic image SP by performing the synthetic aperture process based on the three reconstructed images RP generated by the reconstruction processing unit 72 (Step S16). The display control unit 74 causes the display 51 to display the synthetic image SP generated by the synthetic aperture processing unit 73 (Step S17).

Next, the information processing apparatus 50 determines whether or not the culturing by the incubator 40 is completed (Step S18). The culturing is carried out for a maximum of 7 days from the start of the culturing, for example. The information processing apparatus 50 determines whether or not the culturing is completed based on, for example, an elapsed time from the start of the culturing. In a case where the information processing apparatus 50 determines that the culturing has not been completed (Step S18: NO), the information processing apparatus 50 determines whether or not a certain time (for example, 10 minutes) has elapsed since the previous imaging (Step S19).

In a case where the information processing apparatus 50 determines that a certain time has elapsed since the previous imaging (Step S19: YES), the processing returns to Step S12. The processes of Steps S12 to S19 are repeatedly executed until the determination is affirmed in Step S18. After the information processing apparatus 50 determines in Step S18 that the culturing by the incubator 40 has been completed (Step S18: YES), the user takes out the imaging apparatus 10 from the culture room 41 of the incubator 40 (Step S20).

As described above, the imaging apparatus 10 according to the technology of the present disclosure captures the interference fringe image by lens-free imaging without using an optical lens, so that the apparatus size is small. Therefore, the imaging apparatus 10 can be taken in and out of the culture room 41 of the small incubator 40 for fertilized eggs. The incubator 40 for fertilized eggs is inexpensive because an optical camera or the like is not integrated.

Although a time-lapse incubator with an integrated optical camera or the like is much more expensive than an ordinary incubator, the imaging apparatus 10 of the present disclosure is small and can be taken in and out of the culture room of an ordinary incubator. Therefore, according to the technology of the present disclosure, an inexpensive ordinary incubator can be used as a time-lapse incubator.

Since the imaging apparatus 10 according to the technology of the present disclosure performs lens-free imaging without using an optical lens, the imaging field is wider than that of a microscope or the like using an optical lens in the related art, and the imaging surface 12A of the imaging sensor 12 becomes the imaging field as it is. Therefore, the imaging apparatus 10 can accurately image the entirety of the culture container by one imaging operation by the imaging sensor 12.

The imaging apparatus 10 according to the technology of the present disclosure images the fertilized egg 21 using three light sources 18A, 18B, and 18C having different irradiation angles of the illumination light 16 with respect to the imaging surface 12A of the imaging sensor 12, thereby obtaining information from a plurality of imaging angles, so that depth information of the fertilized egg 21 an be obtained. In the above embodiment, the high-resolution synthetic image SP can be obtained by performing the synthetic aperture process that synthesizes information from a plurality of angles to increase the spatial resolution.

### Modification Example of First Embodiment

Next, a modification example of the first embodiment will be described. In the first embodiment, the light sources 18A, 18B, and 18C are arranged along the Y direction, but the arrangement direction is not limited thereto, and the light sources 18A, 18B, and 18C may be arranged along the X direction. In addition, in the first embodiment, although the illumination device 11 has three light sources 18A, 18B, and 18C, the number of light sources included in the illumination device 11 is not limited to three, and need only be two or more. The illumination device according to the technology of the present disclosure need only have a plurality of light sources that irradiate the culture region with illumination light at different irradiation angles. The expression “irradiate the culture region with illumination light at different irradiation angles” means that an angle formed by one plane (for example, X-Z plane in FIG. 2) including the vertical direction (Z-axis direction) and the central axis of the illumination light is different between at least two illumination light beams.

Each light source included in the illumination device 11 may be a laser light source in which a plurality of light emitting points (for example, 36 light emitting points) are arranged in a two-dimensional array. As this laser light source, a vertical cavity surface emitting laser can be used. A plurality of pieces of image data obtained by performing an imaging operation by the imaging sensor 12 while sequentially emitting a plurality of light emitting points included in one light source are synthesized to obtain one image data DT including a high-resolution interference fringe image (so-called super-resolution interference fringe image).

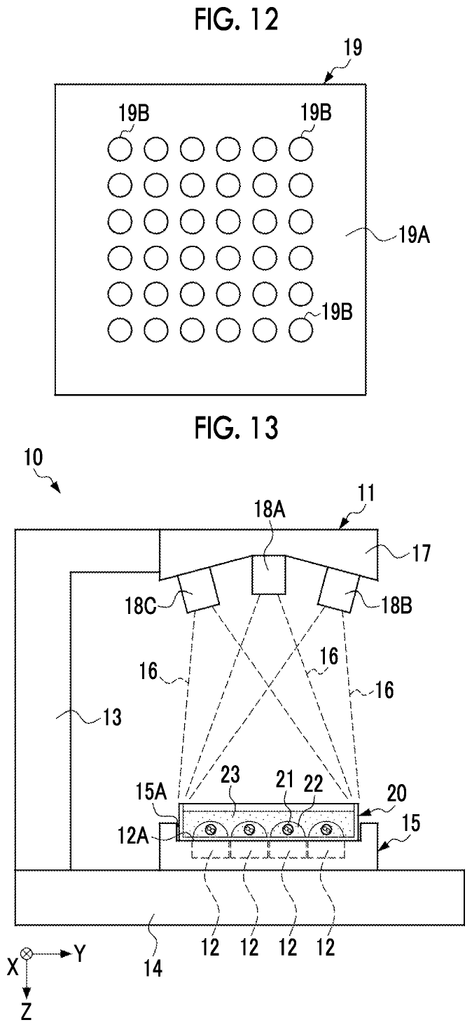

FIG. 12 illustrates a configuration of a light emitting surface 19A of a light source 19 comprising a plurality of light emitting points 19B. The light emitting surface 19A is disposed at a position facing the imaging sensor 12. The plurality of light emitting points 19B are arranged in a two-dimensional array on the light emitting surface 19A. An arrangement pitch of the light emitting points 19B is about 10 μm to 100 μm. The light emitting points 19B are sequentially selected to emit the illumination light 16. An emission time interval of the plurality of light emitting points 19B is several milliseconds.

The arrangement pitch of the light emitting points 19B need only be different from the arrangement pitch of the pixels 12B, and does not necessarily have to be smaller than the arrangement pitch of the pixels 12B. For example, even though the light emitting point 19B is located directly above the adjacent pixel 12B, the arrangement pitch of the light emitting points 19B need not match the arrangement pitch of the pixels 12B. In this case, since the illumination light 16 is illuminated at different positions on the pixel 12B, in a case of synthesizing the plurality of pieces of image data, it is possible to generate one image data DT including a super-resolution interference fringe image by regarding the different pixels 12B, which are directly below the respective light emitting points 19B and are illuminated by the illumination light 16, as the same pixel and performing registration with an accuracy of 1 pixel or less.

In FIG. 12, although the light emitting points 19B are arranged in a 6×6 square arrangement, and 36 light emitting points 19B are provided on the light emitting surface 19A, the number and the arrangement pattern of the light emitting points 19B are not limited to the number and the arrangement pattern shown in FIG. 12. As the number of the light emitting points 19B increases, the resolution of the interference fringe image can be increased, while the operation time of the synthetic process and the reconstruction process becomes longer. Therefore, it is preferable to optimize the number of the light emitting points 19B in accordance with the required image quality and operation time.

In the first embodiment, the synthetic image SP including the depth information of the fertilized egg 21 is generated by performing the synthetic aperture process based on the plurality of reconstructed images RP generated by the reconstruction processing unit 72. Since the plurality of reconstructed images RP generated by the reconstruction processing unit 72 are images in which the irradiation angles of the illumination light 16 with respect to the fertilized egg 21 are different, a three-dimensional image may be acquired by performing the operation processing using a filter back projection method or the like used in radiation tomosynthesis imaging or the like.

In the first embodiment, although the entirety of the culture region is imaged by one imaging sensor 12, the entirety of the culture region may be imaged by a plurality of imaging sensors 12. For example, as shown in FIG. 13, one imaging sensor 12 may be provided for each fertilized egg 21 existing in the culture region. In this case, the image data DT including one interference fringe image 33 (see FIG. 6) is output from each imaging sensor 12. The reconstruction processing unit 72 generates the reconstructed image RP by performing the reconstruction process on the image data DT output from each of the imaging sensors 12. The synthetic aperture processing unit 73 generates the synthetic image SP by using three reconstructed images RP for each imaging sensor 12. That is, the synthetic images SP corresponding to the number of the imaging sensors 12 are generated.

As described above, the imaging apparatus according to the technology of the present disclosure need only comprise at least one imaging sensor that images the entirety of the culture region.

### Second Embodiment

Next, the second embodiment will be described. The second embodiment is the same as the first embodiment except that the functions of the processor 55 of the information processing apparatus 50 are different.

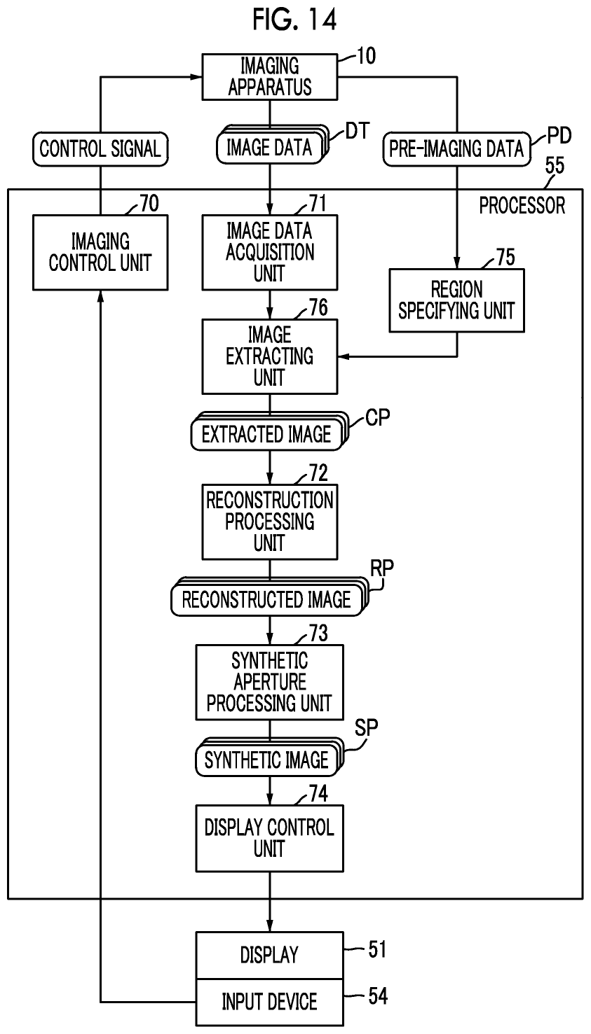

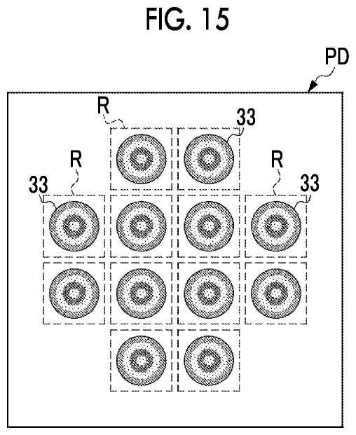

FIG. 14 is a block diagram showing a functional configuration of the information processing apparatus 50 according to the second embodiment. The function of the information processing apparatus 50 is realized by the processor 55 executing processing based on the operation program 56A. As shown in FIG. 14, the processor 55 includes a region specifying unit 75 and an image extracting unit 76 in addition to the imaging control unit 70, the image data acquisition unit 71, the reconstruction processing unit 72, the synthetic aperture processing unit 73, and the display control unit 74.

In the present embodiment, the imaging control unit 70 emits the illumination light 16 from one of the three light sources 18A, 18B, and 18C before executing the imaging operation for generating the three pieces of image data DT, and causes the imaging sensor 12 to execute an imaging operation (hereinafter, referred to as a pre-imaging operation). For example, in the pre-imaging operation, the illumination light 16 is emitted to the light source 18A located directly above the imaging sensor 12. In the present embodiment, pre-imaging data PD is output in a case where the imaging apparatus 10 performs the pre-imaging operation.

The region specifying unit 75 specifies a region in which the fertilized egg 21, which is an observation object, exists (hereinafter, referred to as an observation object region R) based on the pre-imaging data PD output from the imaging apparatus 10. The region specifying unit 75 supplies information including a plurality of observation object regions R specified from an inside of the culture container 20 to the image extracting unit 76 based on the pre-imaging data PD.

As a result of the main imaging operation using the three light sources 18A, 18B, and 18C, the image extracting unit 76 extracts an image included in the observation object region R from each of the three pieces of image data DT acquired by the image data acquisition unit 71, and outputs the extracted image CP.

In the present embodiment, the reconstruction processing unit 72 generates the reconstructed image RP by performing the reconstruction process on each of the extracted images CP output from the image extracting unit 76. The synthetic aperture processing unit 73 generates the synthetic image SP by using three reconstructed images RP for each observation object region R. That is, the synthetic images SP corresponding to the number of the observation object regions R are generated.

The display control unit 74 causes the display 51 to display a plurality of synthetic images SP generated by the synthetic aperture processing unit 73.

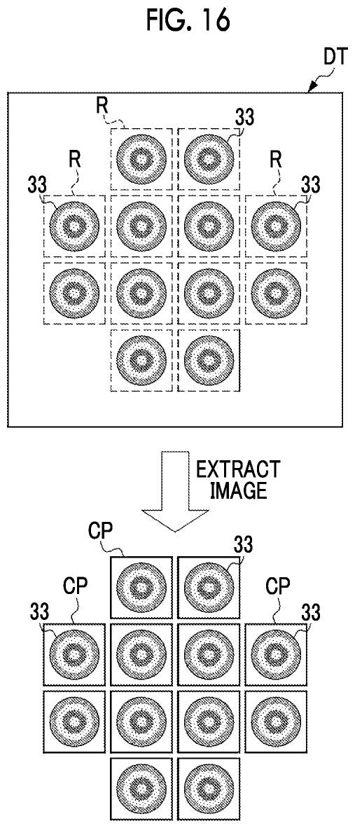

FIG. 15 shows an example of the observation object region R specified by the region specifying unit 75. The region specifying unit 75 specifies a region in which the observation object exists by performing image analysis on the pre-imaging data PD. For example, the region specifying unit 75 specifies a rectangular region including one interference fringe image 33 as the observation object region R by performing template matching using a streak-pattern as a template.

FIG. 16 shows an example of the image extraction process by the image extracting unit 76. The image extracting unit 76 extracts an image included in the observation object region R from each image data DT and uses it as the extracted image CP. The extracted image CP includes one interference fringe image 33.

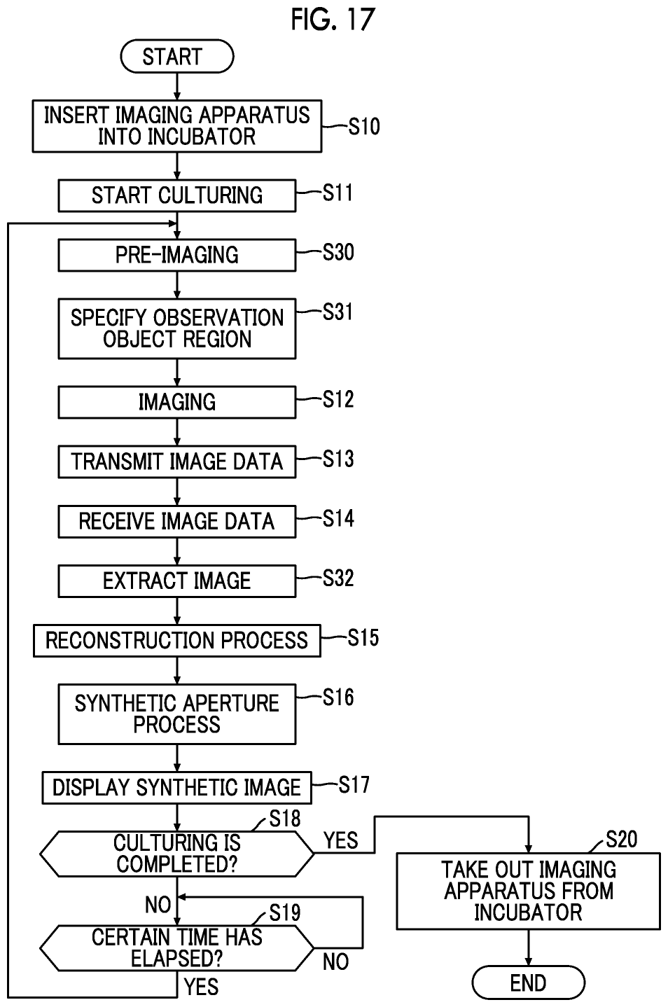

FIG. 17 is a flowchart showing an example of the overall operation of the time-lapse imaging system 2 according to the second embodiment. In the flowchart shown in FIG. 17, Steps S30 to S32 are added to the flowchart shown in FIG. 11. The operations of Steps S10 to S20 are basically the same as those of the first embodiment.

In the present embodiment, after Step S11, the imaging apparatus 10 performs a pre-imaging operation based on the control from the information processing apparatus 50 (Step S30). The pre-imaging data PD generated by the imaging apparatus 10 is wirelessly transmitted to the information processing apparatus 50.

The region specifying unit 75 of the information processing apparatus 50 specifies the observation object region R based on the pre-imaging data PD (Step S31). Information including the observation object region R specified by the region specifying unit 75 is supplied to the image extracting unit 76.

After Step S31, Steps S12 to S14 described above are executed. After Step S14, the image extracting unit 76 extracts an image included in the observation object region R from each of the pieces of image data DT acquired in Step S14, and supplies the extracted image CP to the reconstruction processing unit 72 (Step S32). In Step S15, the reconstruction processing unit 72 generates the reconstructed image RP by performing the reconstruction process on each of the extracted images CP output from the image extracting unit 76.

As described above, in the present embodiment, the reconstruction processing unit 72 performs reconstruction using an extracted image CP having a small size extracted from the image data DT instead of performing reconstruction using the entire image data DT, so that the reconstruction process is accelerated. In addition, in the present embodiment, reconstruction is not performed for a region of the image data DT that does not include the fertilized egg 21 which is an observation object, so that useless processing can be omitted. In addition, in the present embodiment, since the synthetic image SP is generated for each fertilized egg 21 which is an observation object, it is possible to manage an image of each fertilized egg 21 individually.

### Modification Example of Second Embodiment

Next, a modification example of the second embodiment will be described. In the second embodiment, the observation object region R is specified based on the pre-imaging data PD obtained by imaging the observation object. Alternatively, the observation object region R may be specified based on information such as the type, the size and/or the shape of the culture container 20.

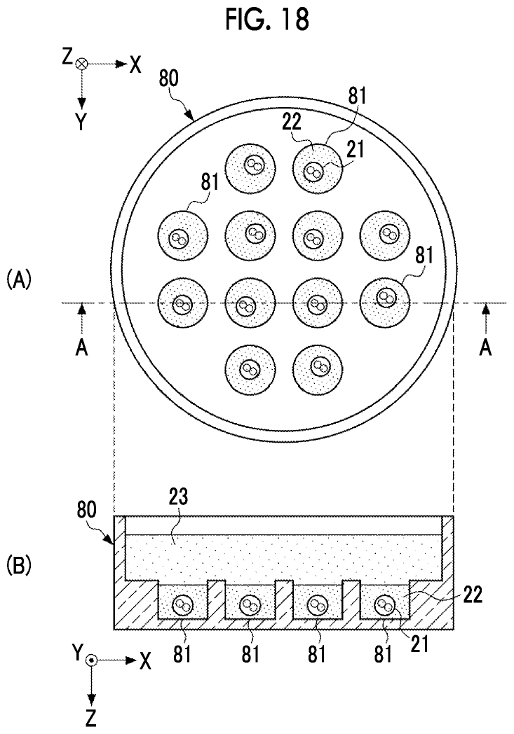

FIG. 18 shows a culture container 80 according to the modification example. (A) of FIG. 18 is a plan view of the culture container 80. (B) of FIG. 18 is a cross-sectional view of the culture container 80 cut along the line A-A shown in (A) of FIG. 18. The culture container 80 is, for example, a culture dish dedicated to fertilized eggs.

A plurality of wells 81 are formed in the culture container 80. The well 81 is a recessed sunken part formed in an inner bottom surface of the culture container 80 such that a position of the fertilized egg 21 can be easily fixed. One fertilized egg 21 is sown in the well 81, and the well 81 is filled with the culture solution 22. The culture container 80 is filled with the oil 23 to cover all the wells 81.

In a case of performing culturing using the culture container 80, the fertilized egg 21, which is an observation object, is cultured in the well 81, so that the observation object region R corresponds to the formation region of the well 81. Therefore, the observation object region R can be specified by grasping the position and the size of the well 81 in the culture container 80.

The size of the culture container 80, the number of the wells 81, and the position and the size of the well 81 differ depending on the type of the culture container 80. Therefore, in the present modification example, the region specifying unit 75 recognizes the type of the culture container 80 based on the pre-imaging data PD, and specifies the observation object region R based on the recognized type of the culture container 80.

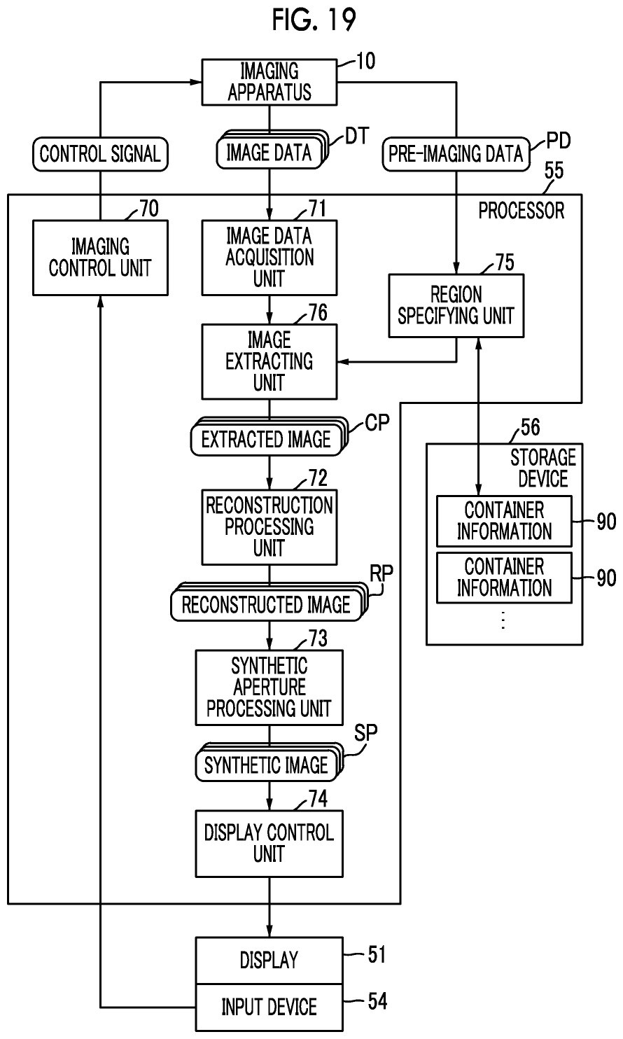

As shown in FIG. 19, it is preferable to store container information 90 in the storage device 56 for each type of the culture container 80. The container information 90 includes information indicating the position and the size of the well 81. The region specifying unit 75 recognizes the type of the culture container 80 based on the pre-imaging data PD, and acquires the container information 90 corresponding to the recognized type of the culture container 80 from the storage device 56. Then, the region specifying unit 75 specifies the observation object region R based on the acquired container information 90.

The region specifying unit 75 may specify the observation object region R based on input information (maker information or the like) input from the input device 54 or the like of the information processing apparatus 50 without using the pre-imaging data PD. For example, the region specifying unit 75 may recognize the type of the culture container 80 based on the input information input from the input device 54 or the like, and may acquire the container information 90 corresponding to the recognized type of the culture container 80 from the storage device 56.

Various modification examples of the first embodiment described above can also be applied to the second embodiment. In the first embodiment and the second embodiment, although the observation object is a fertilized egg, the observation object is not limited to the fertilized egg. The observation object may be a floating cell other than the fertilized egg. The floating cell is a cell that floats in a culture solution. In addition to the fertilized eggs, the floating cells include Chinese hamster ovary (CHO) cells used for antibody production.

The time-lapse imaging system 2 according to the first embodiment and the second embodiment relates to a technology called lens-free imaging in which the imaging apparatus 10 does not comprise an optical lens. The technology of the present disclosure is applicable to digital holography in general (for example, in a case where reference light is used).

A hardware configuration of a computer constituting the information processing apparatus 50 can be modified in various ways. For example, the information processing apparatus 50 can be configured by a plurality of computers separated as hardware for the purpose of improving processing capacity and reliability.

As described above, the hardware configuration of the computer of the information processing apparatus 50 can be appropriately changed according to the required performance such as processing capacity, safety, and reliability. Further, not only the hardware but also the application program such as the operation program 56A can be duplicated or stored in a plurality of storage devices in a distributed manner for the purpose of securing safety and reliability.

The hardware structures of processing units that execute various kinds of processing, such as the image data acquisition unit 71, the reconstruction processing unit 72, the synthetic aperture processing unit 73, the display control unit 74, the region specifying unit 75, and the image extracting unit 76 can use various processors described below. As described above, the various processors include, in addition to the CPU that is a general-purpose processor that executes software (operation program 56A) to function as various processing units, a programmable logic device (PLD) that is a processor capable of changing a circuit configuration after manufacture, such as an FPGA, and an exclusive electric circuit that is a processor having a circuit configuration exclusively designed to execute specific processing, such as an application specific integrated circuit (ASIC).

One processing unit may be constituted by one of these various processors, or may be a combination of two or more processors of the same type or different types (for example, a combination of a plurality of FPGAs and/or a combination of a CPU and an FPGA). A plurality of processing units may be constituted by one processor.

As an example in which the plurality of processing units are constituted by one processor, first, as represented by a computer such as a client and a server, one processor is constituted by a combination of one or more CPUs and software and this processor functions as the plurality of processing units. Second, as represented by a system on chip (SoC), a processor that realizes the functions of the entire system including the plurality of processing units by using one integrated circuit (IC) chip is used. As described above, the various processing units are constituted by using one or more of the various processors described above as a hardware structure.

Further, as the hardware structure of these various processors, more specifically, an electric circuit (circuitry) in which circuit elements such as semiconductor elements are combined can be used.

The above-described embodiments and modification examples can be appropriately combined to the extent that no contradiction occurs.

All documents, patent applications, and technical standards described in the present specification are incorporated into the present specification by reference to the same extent as in a case where the individual documents, patent applications, and technical standards were specifically and individually stated to be incorporated by reference.

### EXPLANATION OF REFERENCES

2: time-lapse imaging system
10: imaging apparatus
11: illumination device
12: imaging sensor
12A: imaging surface
12B: pixel
13: support column
14: base
15: stage
15A: placing part
16: illumination light
17: base
18A, 18B, 18C: light source
19: light source
19A: light emitting surface
19B: light emitting point
20: culture container
20A: inner bottom surface
21: fertilized egg
22: culture solution
23: oil
30: diffracted light
31: transmitted light
33: interference fringe image
36: bright portion
38: dark portion
40: incubator
41: culture room
42: lid
43: switch
50: information processing apparatus
51: display
52: keyboard
53: mouse
54: input device
55: processor
56: storage device
56A: operation program
57: communication unit
58: busline
60: processor
61: storage device
62: communication unit
63: power feed unit
64: battery
65: busline
70: imaging control unit
71: image data acquisition unit
72: reconstruction processing unit
73: synthetic aperture processing unit
74: display control unit
75: region specifying unit
76: image extracting unit
80: culture container
81: well
90: container information
CP: extracted image
DT: image data
P: reconstruction position
PD: pre-imaging data
R: observation object region
RP: reconstructed image
SP: synthetic image

What is claimed is:

1. An imaging apparatus that generates image data including an interference fringe image by imaging an observation object existing in a culture region of a culture container, the imaging apparatus comprising:
a plurality of light sources that irradiate the culture region with illumination light at different irradiation angles; and
at least one imaging sensor that generates the image data by imaging an entirety of the culture region each time each of the plurality of light sources irradiates the culture region with the illumination light,
wherein the imaging apparatus is configured to be taken in and out of a culture room provided in an incubator.

2. The imaging apparatus according to claim 1,
wherein the observation object is a fertilized egg or a floating cell.

3. The imaging apparatus according to claim 1,
wherein a plurality of the observation objects exist in the culture region, and
the imaging sensor simultaneously images the plurality of observation objects.

4. The imaging apparatus according to claim 2,
wherein a plurality of the observation objects exist in the culture region, and
the imaging sensor simultaneously images the plurality of observation objects.

5. The imaging apparatus according to claim 1,
wherein the light source has a plurality of light emitting points, and
the imaging sensor generates a plurality of pieces of the image data by performing an imaging operation each time each of the light emitting points emits light.

6. The imaging apparatus according to claim 2,
wherein the light source has a plurality of light emitting points, and
the imaging sensor generates a plurality of pieces of the image data by performing an imaging operation each time each of the light emitting points emits light.

7. The imaging apparatus according to claim 3,
wherein the light source has a plurality of light emitting points, and
the imaging sensor generates a plurality of pieces of the image data by performing an imaging operation each time each of the light emitting points emits light.

8. The imaging apparatus according to claim 4,
wherein the light source has a plurality of light emitting points, and
the imaging sensor generates a plurality of pieces of the image data by performing an imaging operation each time each of the light emitting points emits light.

9. The imaging apparatus according to claim 1,
wherein a plurality of the imaging sensors are provided, and
one imaging sensor is provided for each observation object existing in the culture region.

10. The imaging apparatus according to claim 2,
wherein a plurality of the imaging sensors are provided, and
one imaging sensor is provided for each observation object existing in the culture region.

11. The imaging apparatus according to claim 3,
wherein a plurality of the imaging sensors are provided, and
one imaging sensor is provided for each observation object existing in the culture region.

12. The imaging apparatus according to claim 4,
wherein a plurality of the imaging sensors are provided, and
one imaging sensor is provided for each observation object existing in the culture region.

13. The imaging apparatus according to claim 5,
wherein a plurality of the imaging sensors are provided, and
one imaging sensor is provided for each observation object existing in the culture region.

14. The imaging apparatus according to claim 6,
wherein a plurality of the imaging sensors are provided, and
one imaging sensor is provided for each observation object existing in the culture region.

15. The imaging apparatus according to claim 7,
wherein a plurality of the imaging sensors are provided, and
one imaging sensor is provided for each observation object existing in the culture region.

16. The imaging apparatus according to claim 1, further comprising:
a communication portion that wirelessly transmits the image data.

17. An information processing apparatus comprising:
a processor that generates a reconstructed image by receiving the image data transmitted from the imaging apparatus according to claim 16 and performing a reconstruction process based on the received image data.

18. The information processing apparatus according to claim 17,
wherein the processor
specifies an observation object region in which the observation object exists based on pre-imaging data outputted from the imaging apparatus obtained by imaging the entirety of the culture region with one of the plurality of light sources before executing the imaging operation for generating the image data, and
generates the reconstructed image by extracting an image corresponding to the observation object region from the image data and performing the reconstruction process on the extracted image.

19. The information processing apparatus according to claim 17,
wherein the processor
specifies an observation object region in which the observation object exists based on information of the culture container, and
generates the reconstructed image by extracting an image corresponding to the observation object region from the image data and performing the reconstruction process on the extracted image.

20. The information processing apparatus according to claim 17,
wherein the processor generates a synthetic image by performing a synthetic aperture process on a plurality of the reconstructed images corresponding to the plurality of light sources.
